(19) United States
(12) Patent Application Publication
(10) Pub. No.: US 2020/0402214 A1
(43) Pub. Date: Dec. 24, 2020

(54) METHOD AND ELECTRONIC DEVICE FOR RENDERING BACKGROUND IN IMAGE

(71) Applicant: Samsung Electronics Co., Ltd., Suwon-si, Gyeonggi-do (KR)

(72) Inventors: Debayan MUKHERJEE, Bangalore (IN); Amit Kumar SONI, Bangalore (IN); Ritesh Ranjan SINGH, Bangalore (IN); Vishal Bhushan JHA, Bangalore (IN); Vishnupriya Surendranath KAULGUD, Bangalore (IN); Ashika SINGH, Bangalore (IN); Alok Shankarlal SHUKLA, Bangalore (IN); Girish KULKARNI, Bangalore (IN); Kiran Nanjunda IYER, Bangalore (IN); Madhupa CHOWDHURY, Bangalore (IN); Saketh SHARMA, Bangalore (IN); Balvinder SINGH, Bangalore (IN); Dipesh Amritlal SHAH, Bangalore (IN); Narasimha Gopalakrishna PAI, Bangalore (IN); Prasanna Kumar AVANIGADDA, Bangalore (IN); Raushan KUMAR, Bangalore (IN); Roopa Sheshadri KOTIGANAHALLY, Bangalore (IN); Saumitri CHOUDHURY, Bangalore (IN); Viswanath GOPALAKRISHNAN, Bangalore (IN)

(21) Appl. No.: 16/968,402

(22) PCT Filed: Feb. 8, 2019
(86) PCT No.: PCT/KR2019/001580

§ 371 Date: Aug. 7, 2020

(30) Foreign Application Priority Data
Feb. 8, 2018 (IN) 201841004828
Feb. 7, 2019 (IN) 2018 41004828

(51) Int. Cl. G06T 5/00; G06T 5/50; G06T 7/194; G06T 7/11

(52) U.S. Cl. CPC G06T 5/004; G06T 7/11; G06T 7/194; G06T 5/50

(57) ABSTRACT

Accordingly the embodiments herein provide a method for rendering a background in an image by an electronic device (100). The method includes recognizing, by the electronic device (100), foreground objects and background objects of the image. Further, the method includes determining, by the electronic device (100), a context of the foreground objects and a context of the background objects in the image. Further, the method includes determining, by the electronic device (100), a background pattern based on the context of the foreground objects and the context of the background objects. Further, the method includes modifying, by the electronic device (100), the background of the image based on the background pattern. Further, the method includes displaying, by the electronic device (100), the image with the modified background.

### CROSS-REFERENCE TO RELATED APPLICATION(S)

This application is a National Phase Entry of PCT International Application No. PCT/KR2019/001580, which was filed on Feb. 8, 2019, and claims priority to Indian Provisional Patent Application No. 201841004828 filed on Feb. 8, 2018, and Indian Complete Patent Application No. 201841004828 filed on Feb. 7, 2019, in the Indian Intellectual Property Office, the content of each of which are incorporated herein by reference.

### TECHNICAL FIELD

The present disclosure relates to image processing methods, and more specifically to a method and electronic device for rendering a background in an image.

### BACKGROUND ART

Bokeh effect in photography is used to produce an aesthetic blur for an out-of-focus region/objects (i.e. background region/objects) of an image for highlighting an in-focus region/objects (i.e. foreground region/objects) of the image. Therefore, objects present in the in-focus region of the image captures an attention of a viewer, which enhances a visual experience of the viewer in seeing the image. While capturing the image with the bokeh effect, existing systems provide a set of pattern such as a butterfly shape, a star shape, a heart shape, etc. to the viewer for selecting a pattern. Further, the existing systems modify objects in the out-of-focus region of the image based on the selected pattern, for extending the visual experience of the user. However, the user need to manually choose a suitable pattern for a scene in the image, the objects in the in-focus region, a time of capturing the image etc. from the set of the pattern for modifying the objects in the out-of-focus region.

Thus, it is desired to address the above mentioned shortcomings or at least provide a useful alternative.

### DISCLOSURE OF INVENTION

### Solution to Problem

Accordingly the embodiments herein provide a method for rendering a background in an image by an electronic device. The method includes recognizing, by the electronic device, foreground objects and background objects of the image. Further, the method includes determining, by the electronic device, a context of the foreground objects and a context of the background objects in the image. Further, the method includes determining, by the electronic device, a background pattern based on the context of the foreground objects and the context of the background objects. Further, the method includes modifying, by the electronic device, the background of the image based on the background pattern. Further, the method includes displaying, by the electronic device, the image with the modified background.

In an embodiment, modifying by the electronic device, the background of the image based on the background pattern including determining an effect and at least one of a shape, an object, and a surface based on the background pattern and transforming at least one of a shape, an object, and a surface available in the background of the image with at least one of the shape, the object, and the surface based on the effect.

In an embodiment, the transforming is done by at least one of blurring the shape, the object, and the surface available in the background of the image based on the effect, overlaying the shape, the object, and the surface in the background pattern over the shape, the object, and the surface available in the background of the image based on the effect and replacing the shape, the object, and the surface available in the background of the image with the shape, the object, and the surface in the background pattern based on the effect.

In an embodiment, determining by the electronic device, the context of the foreground objects including determining a dominant foreground object from the foreground objects based on at least one of an activity in a foreground, an event information, a shape of the foreground object, a size of the foreground object, and a motion of the foreground object, classifying the dominant foreground object and determining the context of the foreground objects based on the category of the dominant foreground object.

In an embodiment, determining by the electronic device (100), the context of the background objects including determining a dominant background object from the background objects based on at least one of an activity in the background, an event information, a shape of the background object, a size of the background object, and a motion of the background object, classifying the dominant background object and determining the context of the background objects based on the category of the dominant background object.

Accordingly the embodiments herein provide an electronic device for rendering a background in an image. The electronic device including a memory, a processor and a background modification engine, coupled to the memory and the processor, where the memory stores the image. The background modification engine is configured to recognize foreground objects and background objects in the image. Further, the background modification engine is configured to determine a context of the foreground objects and a context of the background objects in the image. Further, the background modification engine is configured to determine a background pattern based on the context of the foreground objects and the context of the background objects. Further, the background modification engine is configured to modify the background of the image based on the background pattern. Further, the background modification engine is configured to cause to display the image with the modified background.

Accordingly the embodiments herein provide an intelligent background rendering method in an image capture. The method includes identifying objects and/or surfaces present in a background of a captured shot. Further, the method includes performing scene analysis to recognize a shape of each object and/or surface in the background. Further, the method includes performing scene analysis of objects present in a foreground to determine a context of the captured shot. Further, the method includes configuring an artificial intelligence engine to identify pre-defined shapes and/or patterns from a repository, relating to the context of the captured shot. Further, the method includes transforming at least in part, the shape of the objects and/or surfaces present in the background with that of the pre-defined shapes and/or patterns relating to the context of the captured shot.

In an embodiment, transforming at least in part, the shape of the objects and/or surfaces present in the background with that of the pre-defined shapes and/or patterns relating to the context of the captured shot includes recommending the shape of the objects and/or surfaces present in the background with that of the pre-defined shapes and/or patterns relating to the context of the captured shot.

In an embodiment, the objects and/or surfaces in the background are blurred.

In an embodiment, transforming the shape includes overlaying the objects and/or surfaces with the pre-defined shapes.

In an embodiment, transforming the shape includes replacing the objects and/or surfaces with the pre-defined shapes.

Accordingly the embodiments herein provide an electronic device for intelligent background rendering an image capture. The electronic device including a processor, a memory, an artificial intelligence engine and a background modification engine, where the artificial intelligence engine and the background modification engine are coupled to the memory and the processor. The memory stores a captured shot. The background modification engine is configured to identify objects and/or surfaces present in a background of the captured shot. Further, the background modification engine is configured to perform scene analysis to recognize a shape of each object and/or surface in the background. Further, the background modification engine is configured to perform scene analysis of objects present in a foreground to determine a context of the captured shot. Further, the background modification engine is configured to configure an artificial intelligence engine to identify pre-defined shapes and/or patterns from a repository, relating to the context of the captured shot. Further, the background modification engine is configured to transform at least in part, the shape of the objects and/or surfaces present in the background with that of the pre-defined shapes and/or patterns relating to the context of the captured shot.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

The principal object of the embodiments herein is to provide a method and electronic device for rendering a background in an image.

Another object of the embodiments herein is to recognize foreground objects and background objects of the image.

Another object of the embodiments herein is to determine a context of the foreground objects and a context of the background objects in the image.

Another object of the embodiments herein is to determine a background pattern based on the context of the foreground objects and a context of the background objects.

Another object of the embodiments herein is to modify the background of the image based on the background pattern and display the image with the modified background.

### BRIEF DESCRIPTION OF DRAWINGS

This method and system is illustrated in the accompanying drawings, throughout which like reference letters indicate corresponding parts in the various figures. The embodiments herein will be better understood from the following description with reference to the drawings, in which:

FIG. 1 is a block diagram of an electronic device for rendering a background in an image, according to an embodiment as disclosed herein;

FIG. 2 is a block diagram of a background modification engine in the electronic device for modifying the background of the image based on a background pattern, according to an embodiment as disclosed herein;

FIG. 3 is a flow diagram illustrating a method for rendering the background in the image by the electronic device, according to an embodiment as disclosed herein;

FIG. 4 is a flow diagram illustrating an intelligent background rendering method in an image capture, according to an embodiment as disclosed herein;

FIGS. 5A and 5B illustrate objects and shapes in the background of the background pattern used for modifying the background of the image, according to an embodiment as disclosed herein;

FIG. 6 is a schematic diagram illustrating steps in modifying the background of the image, according to an embodiment as disclosed herein;

FIG. 7 illustrates an example scenario of modifying the background of the image based on a time information and a location information in the image by the electronic device, according to an embodiment as disclosed herein;

FIG. 8 illustrates an example scenario of modifying the background of the image based image based on an emotion in a foreground of the image and the time information and the location information in the image by the electronic device, according to an embodiment as disclosed herein;

FIG. 9 illustrates an example scenario of modifying the background of the image based on a dominant foreground object and a greenery in the background of the image by the electronic device, according to an embodiment as disclosed herein;

FIG. 10 illustrates an example scenario of modifying the background of the image based on the dominant foreground object and a weather information in the image by the electronic device, according to an embodiment as disclosed herein;

FIG. 11 illustrates an example scenario of modifying the background of the image based on the dominant foreground object and the greenery in the background of the image by the electronic device, according to an embodiment as disclosed herein;

FIG. 12 illustrates an example scenario of modifying the background of the image based on the dominant foreground object and a motion of the foreground object by the electronic device, according to an embodiment as disclosed herein;

FIG. 13 illustrates an example scenario of transforming an object available in the background of the image with a shape available in the background pattern by the electronic device, according to an embodiment as disclosed herein; and

FIG. 14 illustrates an example scenario of recommending the object available in the background pattern based on the time information in the image by the electronic device for modifying the background of the image, according to an embodiment as disclosed herein.

### BEST MODE FOR CARRYING OUT THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly the embodiments herein provide a method for rendering a background in an image by an electronic device. The method includes recognizing, by the electronic device, foreground objects and background objects of the image. Further, the method includes determining, by the electronic device, a context of the foreground objects and a context of the background objects in the image. Further, the method includes determining, by the electronic device, a background pattern based on the context of the foreground objects and the context of the background objects. Further, the method includes modifying, by the electronic device, the background of the image based on the background pattern. Further, the method includes displaying, by the electronic device, the image with the modified background.

Unlike existing methods, the proposed method can be used in an electronic device for determining the background pattern, suitable for a scene in the image. The electronic device selects the background pattern based on a location information in the image, a time information in the image, a weather information in the image, characteristics such as a size, a motion, an activity etc. of dominant objects in foreground and background of the image etc. Therefore, modification includes one of blurring, overlaying and replacing a shape/object/background surface in the image using the background pattern for enhancing a visual experience of a user.

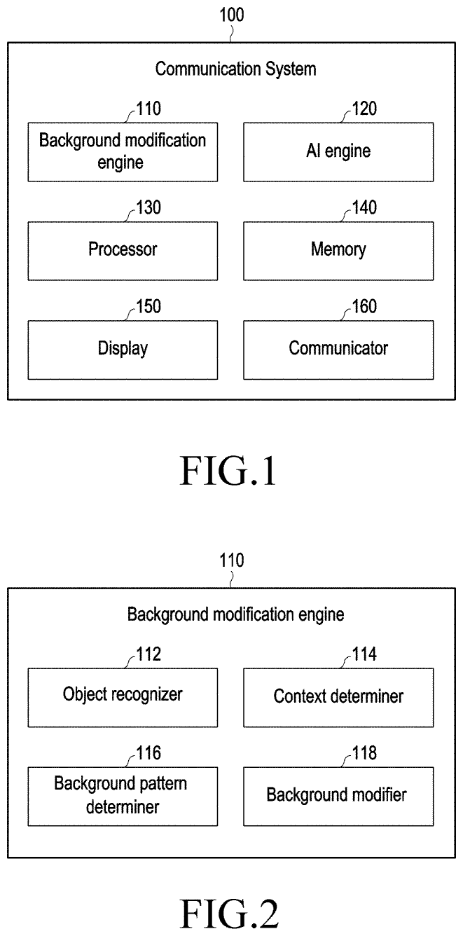

Referring now to the drawings, and more particularly to FIGS. 1 through 14, there are shown preferred embodiments.

FIG. 1 is a block diagram of an electronic device 100 for rendering a background in an image, according to an embodiment as disclosed herein. Example for the electronic device 100 but not limited to a smart phone, a tablet computer, a personal computer, a desktop computer, a personal digital assistance (PDA), a multimedia device, a still camera, a video camera or the like. In an embodiment, electronic device 100 includes a background modification engine 110, an Artificial Intelligence (AI) engine 120, a processor 130, a memory 140, a display 150 and a communicator 160, where the background modification engine 110 and the AI engine 120 are coupled to the processor 130 and the memory 140. The background modification engine 110 fetches the image (i.e. a captured shot of a scene and/or objects) stored in the memory 140. In an embodiment, the image is one of a still image, an animated image, a video. The background modification engine 110 is configured to recognize foreground objects and background objects in the image. Further, the background modification engine 110 is configured to determine a context of the foreground objects and a context of the background objects in the image.

In an embodiment, the background modification engine 110 is configured to determine the dominant foreground object from the foreground objects based on at least one of an activity in the foreground, an event information, a shape of the foreground object, a size of the foreground object, and a motion of the foreground object, for determining the context of the foreground objects.

Examples for the activity are, but not limited to playing guitar, holding lamp etc. Examples for the event information are, but not limited to information about festivals (e.g. Christmas, Ramadan, Diwali, etc.), information about a party (e.g., birthday party, wedding reception etc.), information about a sports/campfire etc. In an embodiment, an emotion (e.g. sad, happy, cry etc.) in the foreground is used to determine the activity in the foreground by the background modification engine 110. In an embodiment, at least one of a weather information (e.g. snow, rain etc.), a location information (e.g. beach, mountain, indoor, outdoor, etc.), a type of a scene and a time information (e.g., day time, night time, solar eclipse, 2 PM etc.) is used to determine the event information by the background modification engine 110. Examples for the type of the scene are, but not limited to a scene of sand, a scene of a beach, a scene of a park, a scene of a sea, a scene of greenery, a scene of traffic etc. In an embodiment, the background modification engine 110 is configured to determine a type of the foreground object for determining the context of the foreground objects. Examples for the type of the foreground object are, but not limited to a cup, a wineglass, a car, a camera, spectacles, a flower, grass etc. Examples for the motion of the foreground object are, but not limited to the motion of the foreground object moving towards to the electronic device 100, the motion of the foreground object moving away from the electronic device 100, the motion of the foreground object moving parallel to the electronic device 100 etc.

In an example, the electronic device 100 captures the image of a group of friends siting inside a restaurant by holding a cup of tea by each person, during the night time, where the friends are in the happy mood. The background of the image includes chairs and decoration light. The electronic device 100 recognizes the group of friends and the cups as the foreground objects. Further, the electronic device 100 determines the group of friends as the dominant foreground object based on the emotion (i.e. happy) in the foreground.

The background modification engine 110 is configured to classify the dominant foreground object for determining the context of the foreground objects. Examples for the classes for dominant foreground object are Flower, Dog/Cat, Birds, Car/Bike, Food, Cup/Mug, Desserts, First generic class etc. Further, the background modification engine 110 is configured to determine the context of the foreground objects based on the classification of the dominant foreground object.

In an embodiment, background modification engine 110 is configured to determine the dominant background object from the background objects based on at least one of the activity in the background, the event information, the shape of the background object, the size of the background object, and the motion of the background object, for determining the context of the background objects.

In an embodiment, the emotion (e.g. sad, happy, cry etc.) in the background is used to determine the activity in the background by the background modification engine 110. In an embodiment, at least one of the type of the scene, the weather information, the location information and the time information is used to determine the event information by the background modification engine 110. In an embodiment, the background modification engine 110 is configured to determine a type of the background object for determining the context of the background objects. Examples for the type of the background object are, but not limited to the car, a train, buildings, a decoration light, people etc. Examples for the motion of the background object are, but not limited to the motion of the background object coming towards the fixed camera, the motion of the background object moving parallel to the camera motion etc.

In the example, the electronic device 100 recognizes the chairs and the decoration light as the background objects. The electronic device 100 determines the decoration light as the dominant background object based on the time information (i.e. night time).

The background modification engine 110 is configured to classify the dominant background object for determining the context of the background objects. Examples for the classes for the dominant background object are Greenery, Beach, Snow, Day and gathering, Night and outdoor, Day, Night and gathering, second generic class etc. Further, the background modification engine 110 is configured to determine the context of the background objects based on the classification of the dominant background object.

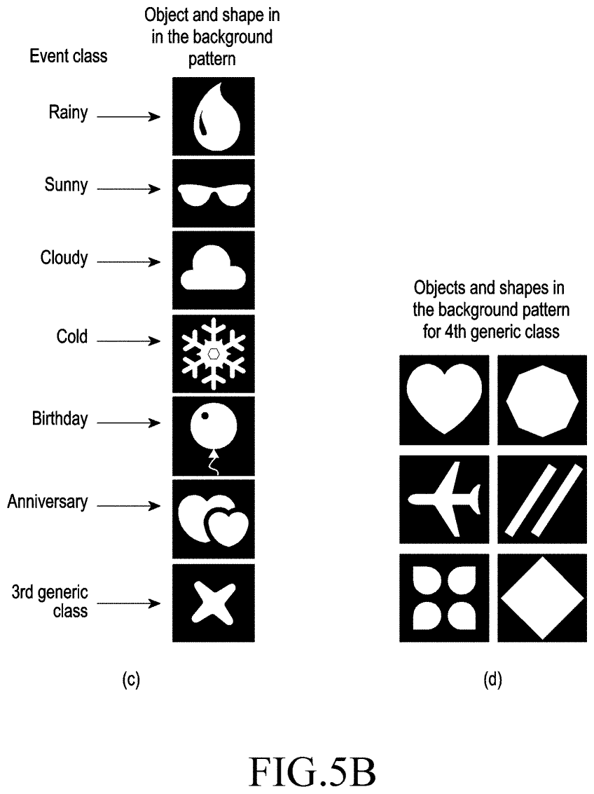

The background modification engine 110 is configured to determine the background pattern (shown in notation (a) and (b) of FIG. 5A) based on the context of the foreground objects and the context of the background objects. In an example, the background pattern is an object (e.g. cloud, leaf, mug, etc.), a shape (e.g. the heart shape, a water drop shape, a leaf shape etc.), a surface (e.g., a plane surface, a red surface, a check surface etc.) etc. The background modification engine 110 is configured to modify the background of the image based on the background pattern.

In an embodiment, the background modification engine 110 is configured to determine an effect (e.g. a blur effect, a warmth effect, a cool effect etc.) and at least one of a shape (e.g. the heart shape, the water drop shape, the leaf shape etc.), an object (e.g. the cloud, the leaf, the mug etc.), and a surface (e.g., a plane surface, a red surface, a check surface etc.) in the based on the background pattern, for modifying the background of the image. Further, the background modification engine 110 is configured to transform at least one of the shape, the object, and the surface available in the background of the image with at least one of the shape, the object, and the surface based on the effect.

In an embodiment, the transformation is done by blurring the shape, the object, and the surface available in the background of the image based on the effect. In another embodiment, the transformation is done by overlaying the shape, the object, and the surface in the background pattern over the shape, the object, and the surface available in the background of the image based on the effect. In another embodiment, the transformation is done by replacing the shape, the object, and the surface available in the background of the image with the shape, the object, and the surface in the background pattern based on the effect.

In another embodiment, the background modification engine 110 is configured to classify at least one of the dominant foreground object and the dominant background object to an event class based on the event information in the image. The event class represents the classification for events such as raining, sunny climate, cloudy climate, a birthday event, a wedding anniversary event etc. Examples for the event class are Rainy, Sunny, Cloudy, Cold, Birthday, Anniversary, Third generic class etc. Further, the background modification engine 110 is configured to determine the context of the foreground objects and the context of the background objects in the image based on the classification of at least one of the dominant foreground object and the dominant background object. Further, the background modification engine 110 is configured to determine the background pattern (shown in notation (c) of the FIG. 5B) based on the context of the foreground objects and the context of the background objects. Further, the background modification engine 110 is configured to modify the background of the image based on the background pattern.

In another embodiment, the background modification engine 110 is configured to classify at least one of the dominant foreground object and the dominant background object to a fourth generic class. Further, the background modification engine 110 is configured to determine the context of the foreground objects and the context of the background objects in the image based on the classification of at least one of the dominant foreground object and the dominant background object. Further, the background modification engine 110 is configured to determine the background pattern (shown in notation (d) of the FIG. 5B) based on the context of the foreground objects and the context of the background objects. Further, the background modification engine 110 is configured to modify the background of the image based on the background pattern. In an embodiment, the background modification engine 110 is configured to classify at least one of the dominant foreground object and the dominant background object to a fourth generic class based on a user action on the electronic device 100. Examples for user action are, but not limited to swiping on the display 150, shaking the electronic device 100, pressing volume up-key/down-key etc.

In another embodiment, the background modification engine 110 is configured to classify the dominant background object to a motion class based on at least one of the motion of the foreground object and the motion of the background object. The motion class indicates a direction of motion of the dominant background object with respect to the electronic device 100, while capturing the image. In an embodiment, the motion class includes a towards motion class, an away motion class and a parallel motion class. The towards motion class indicates the direction of motion of the foreground object moving towards to the electronic device 100, while capturing the image. The away motion class indicates the direction of motion of the foreground object moving away from the electronic device 100, while capturing the image. The parallel motion class indicates the direction of motion of the foreground object moving parallel along with the electronic device 100, while capturing the image. Further, the background modification engine 110 is configured to apply a motion blur effect to the background object, based on the motion class of the dominant foreground object for modifying the background of the image.

In another embodiment, the background modification engine 110 is configured to identify the objects and/or surfaces present in the background of the captured shot. Further, the background modification engine 110 is configured to perform scene analysis to recognize the shape of each object and/or surface in the background. Further, the background modification engine 110 is configured to perform scene analysis of the objects present in the foreground to determine the context of the captured shot. Further, the background modification engine 110 is configured to configure the AI engine 120 to identify the pre-defined shapes and/or patterns from a repository, relating to the context of the captured shot. Further, the background modification engine 110 is configured to transform at least in part, the shape of the objects and/or surfaces present in the background with that of the pre-defined shapes and/or patterns relating to the context of the captured shot. In an embodiment, the background modification engine 110 is configured to recommend the shape of the objects and/or surfaces present in the background with that of the pre-defined shapes and/or patterns relating to the context of the captured shot for transforming at least in part, the shape of the objects and/or surfaces present in the background with that of the pre-defined shapes and/or patterns relating to the context of the captured shot. The AI engine 120 identifies the pre-defined shapes and/or patterns from a repository, relating to the context of the captured shot.

The processor 130 is configured to execute instructions stored in the memory 140 and to perform various operations. The memory 140 stores the image (i.e. the captured shot). The memory 140 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

In addition, the memory 140 may, in some examples, be considered a non-transitory storage medium. The term “non-transitory” may indicate that the storage medium is not embodied in a carrier wave or a propagated signal. However, the term “non-transitory” should not be interpreted that the memory 140 is non-movable. In some examples, the memory 140 can be configured to store larger amounts of information than the memory 140. In certain examples, a non-transitory storage medium may store data that can, over time, change (e.g., in Random Access Memory (RAM) or cache).

The display 150 displays the image with the modified background. Examples for the display 150 are a Liquid Crystal Display (LCD) display, a Light Emitting Diode (LED) display, an Organic Light Emitting Diode (OLED) display etc. The communicator 160 is configured to communicate internally between hardware components in the electronic device 100.

In another embodiment, the electronic device 100 includes the background modification engine 110, the processor 130, the memory 140 and the communicator 160. The communicator 160 is configured to communicate the electronic device 100 with first devices (e.g. web server, smartphone etc.) to receive the image. The background modification engine 110 is configured to modify the background of the image based on the background pattern. Further, the communicator 160 is configured to communicate the electronic device 100 with second devices (e.g. LCD/LED panel, LED TV, projector etc.) for displaying the image with the modified background, where the second devices includes the display 150.

In another embodiment, the electronic device 100 includes the background modification engine 110, the processor 130, the memory 140, the communicator 160 and a camera (not shown). The camera captures the image of a scene, where the image is a real time preview image. The background modification engine 110 is configured to modify the background of the image based on the background pattern. Further, the background modification engine 110 is cause to display the image with the modified background.

Although the FIG. 1 shows the hardware components of the electronic device 100 it is to be understood that other embodiments are not limited thereon. In other embodiments, the electronic device 100 may include less or more number of components. Further, the labels or names of the components are used only for illustrative purpose and does not limit the scope of the invention. One or more components can be combined together to perform same or substantially similar function for rendering the background in the image.

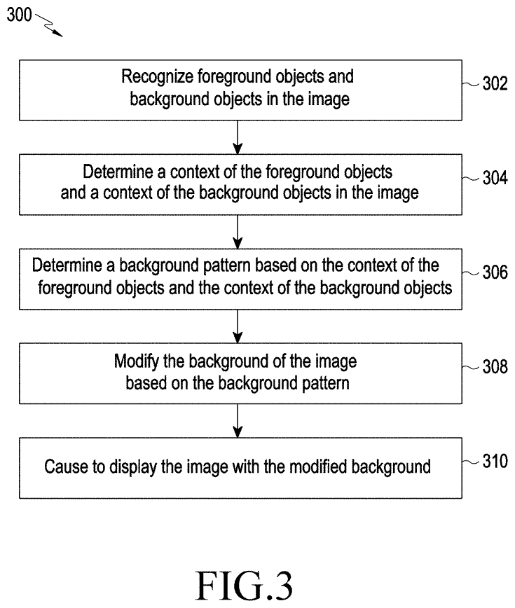

FIG. 2 is a block diagram of the background modification engine 110 in the electronic device 100 for modifying the background of the image based on the background pattern, according to an embodiment as disclosed herein. In an embodiment, the background modification engine 110 includes an object recognizer 112, a context determiner 114, a background pattern determiner 116 and a background modifier 118.

The object recognizer 112 recognizes the foreground objects and the background objects of the image. In an embodiment, the object recognizer 112 identifies the objects and/or surfaces present in the background of the captured shot. In an embodiment, the object recognizer 112 identifies the objects and/or surfaces present in the background of the captured shot. The object recognizer 112 performs the scene analysis to recognize the shape of each object and/or surface in the background. The context determiner 114 determines the context of the foreground objects and the context of the background objects in the image.

In an embodiment, the context determiner 114 determines the dominant foreground object from the foreground objects based on at least one of the activity in the foreground, the event information, the shape of the foreground object, the size of the foreground object, and the motion of the foreground object, for determining the context of the foreground objects.

In an embodiment, the context determiner 114 determines the activity in the foreground based on the emotion in the foreground. In an embodiment, the context determiner 114 determines the event information based on at least one of the weather information, the location information and the time information. In an embodiment, the context determiner 114 determines the context of the foreground objects based on the type of the foreground object.

Further, the context determiner 114 classifies the dominant foreground object for determining the context of the foreground objects. Further, the context determiner 114 determines the context of the foreground objects based on the classification of the dominant foreground object.

In an embodiment, the context determiner 114 determines the dominant background object from the background objects based on at least one of the activity in the background, the event information, the shape of the background object, the size of the background object, and the motion of the background object, for determining the context of the background objects.

In an embodiment, the context determiner 114 determines the activity in the background based on the emotion in the background. In an embodiment, the context determiner 114 determines the event information based on the at least one of the type of the scene, the weather information, the location information and the time information. In an embodiment, the context determiner 114 determines the context of the background objects based on the type of the background object. Further, the context determiner 114 classifies the dominant background object for determining the context of the background objects. Further, the context determiner 114 determines the context of the background objects based on the classification of the dominant background object.

In another embodiment, the context determiner 114 classifies at least one of the dominant foreground object and the dominant background object to the event class based on the event information in the image. Further, the context determiner 114 determines the context of the foreground objects and the context of the background objects in the image based on the classification of at least one of the dominant foreground object and the dominant background object.

In another embodiment, the context determiner 114 classifies at least one of the dominant foreground object and the dominant background object to the fourth generic class. Further, the context determiner 114 determines the context of the foreground objects and the context of the background objects in the image based on the classification of at least one of the dominant foreground object and the dominant background object. In an embodiment, the context determiner 114 classifies at least one of the dominant foreground object and the dominant background object to the fourth generic class based on a user action on the electronic device 100.

In another embodiment, the context determiner 114 performs the scene analysis of the objects present in the foreground to determine the context of the captured shot.

The background pattern determiner 116 determines the background pattern based on the context of the foreground objects and the context of the background objects. The background modifier 118 modifies the background of the image based on the background pattern.

In an embodiment, the background modifier 118 determines the effect and at least one of the shape, the object, and the surface based on the background pattern, for modifying the background of the image. Further, the background modifier 118 transforms at least one of the shape, the object, and the surface available in the background of the image with at least one of the shape, the object, and the surface based on the effect.

In another embodiment, the background modifier 118 transforms at least in part, the shape of the objects and/or surfaces present in the background with that of the pre-defined shapes and/or patterns relating to the context of the captured shot. In another embodiment, the background modifier 118 recommends the shape of the objects and/or surfaces present in the background with that of the pre-defined shapes and/or patterns relating to the context of the captured shot for transforming at least in part, the shape of the objects and/or surfaces present in the background with that of the pre-defined shapes and/or patterns relating to the context of the captured shot.

In another embodiment, the context determiner 114 classifies the dominant background object to the motion class based on at least one of the motion of the foreground object and the motion of the foreground object. Further, the background modifier 118 applies the motion blur effect to the background object, based on the motion class of the foreground object for modifying the background of the background of the image.

Although the FIG. 2 shows the hardware components of the background modification engine 110 it is to be understood that other embodiments are not limited thereon. In other embodiments, the background modification engine 110 may include less or more number of components. Further, the labels or names of the components are used only for illustrative purpose and does not limit the scope of the invention. One or more components can be combined together to perform same or substantially similar function for modifying the background of the image based on the background pattern.

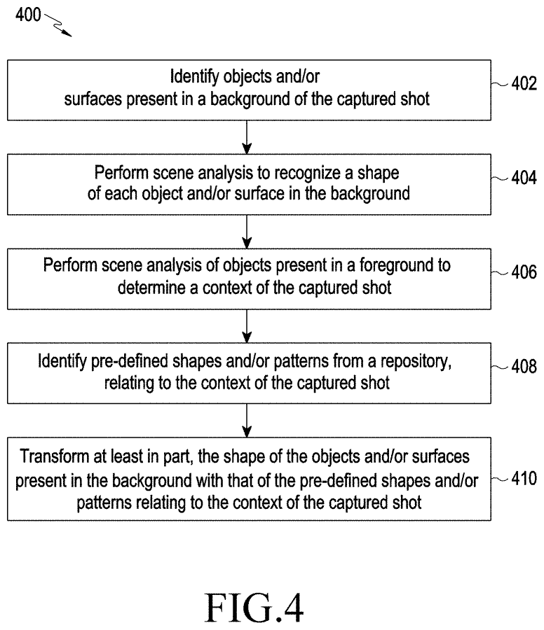

FIG. 3 is a flow diagram 300 illustrating a method for rendering the background in the image by the electronic device 100, according to an embodiment as disclosed herein. At 302, the method includes recognizing the foreground objects and the background objects of the image. In an embodiment, the method allows the object recognizer 112 to recognize the foreground objects and the background objects of the image. At 304, the method includes determine the context of the foreground objects and the context of the background objects in the image. In an embodiment, the method allows the context determiner 114 to determine the context of the foreground objects and the context of the background objects in the image. At 306, the method includes determining the background pattern based on the context of the foreground objects and the context of the background objects. In an embodiment, the method allows the background pattern determiner 116 to determine the background pattern based on the context of the foreground objects and the context of the background objects. At 308, the method includes modifying the background of the image based on the background pattern. In an embodiment, the method allows the background modifier 118 to modify the background of the image based on the background pattern. At 310, the method includes displaying the image with the modified background. In an embodiment, the method allows the display 150 to display the image with the modified background.

The various actions, acts, blocks, steps, or the like in the flow diagram 300 may be performed in the order presented, in a different order or simultaneously. Further, in some embodiments, some of the actions, acts, blocks, steps, or the like may be omitted, added, modified, skipped, or the like without departing from the scope of the invention.

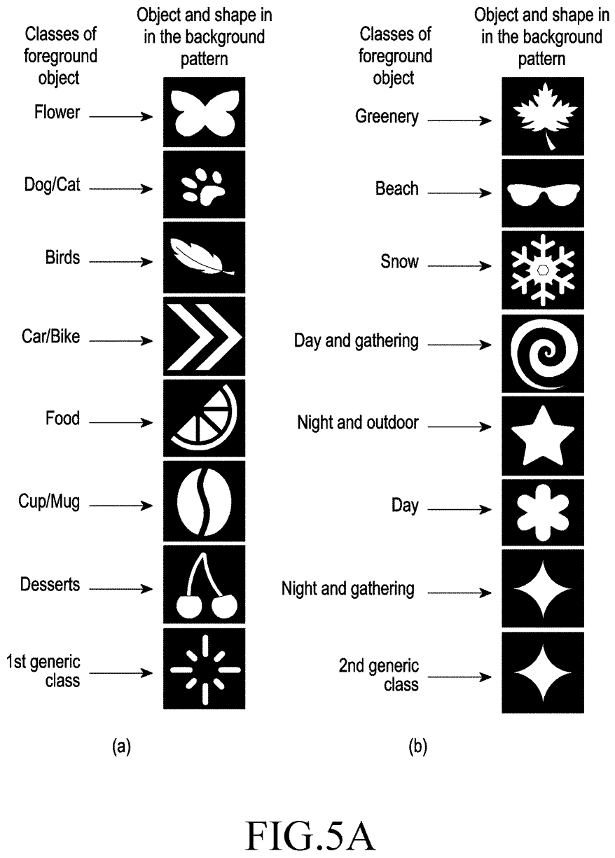

FIG. 4 is a flow diagram 400 illustrating an intelligent background rendering method in the image capture, according to an embodiment as disclosed herein. At 402, the method includes identifying the objects and/or surfaces present in the background of the captured shot. In an embodiment, the method allows the object recognizer 112 to identify the objects and/or surfaces present in the background of the captured shot. At 404, the method includes performing the scene analysis to recognize the shape of each object and/or surface in the background. In an embodiment, the method allows the object recognizer 112 to perform the scene analysis to recognize the shape of each object and/or surface in the background.

At 406, the method includes performing the scene analysis of objects present in the foreground to determine the context of the captured shot. In an embodiment, the method allows the context determiner 114 to perform the scene analysis of objects present in the foreground to determine the context of the captured shot. At 408, the method includes identifying the pre-defined shapes and/or patterns from the repository, relating to the context of the captured shot. In an embodiment, the method allows the AI engine 120 to identify the pre-defined shapes and/or patterns from the repository, relating to the context of the captured shot. At 410, the method includes transforming at least in part, the shape of the objects and/or surfaces present in the background with that of the pre-defined shapes and/or patterns relating to the context of the captured shot. In an embodiment, the method allows the background modifier 118 to transform at least in part, the shape of the objects and/or surfaces present in the background with that of the pre-defined shapes and/or patterns relating to the context of the captured shot.

The various actions, acts, blocks, steps, or the like in the flow diagram 400 may be performed in the order presented, in a different order or simultaneously. Further, in some embodiments, some of the actions, acts, blocks, steps, or the like may be omitted, added, modified, skipped, or the like without departing from the scope of the invention.

FIGS. 5A and 5B illustrate the objects and the shapes in the background pattern used for modifying the background of the image, according to an embodiment as disclosed herein. Various classes for the dominant foreground object are shown in left side of the notation (a) of the FIG. 5A. Further, a corresponding object and shape assigned for each class used for modifying the background of the image is shown in right side of the notation (a) of the FIG. 5A. Various classes for the dominant background object are shown in left side of the notation (b) of the FIG. 5A. Further, the corresponding object and shape assigned for each class used for modifying the background of the image is shown in right side of the notation (b) of the FIG. 5A. Various event classes are shown in left side of the notation (c) of the FIG. 5B. Further, the corresponding object and shape assigned for each event class used for modifying the background of the image is shown in right side of the notation (c) of the FIG. 5B. The objects and shapes assigned for the fourth generic class used for modifying the background of the image is shown in the notation (d) of the FIG. 5B.

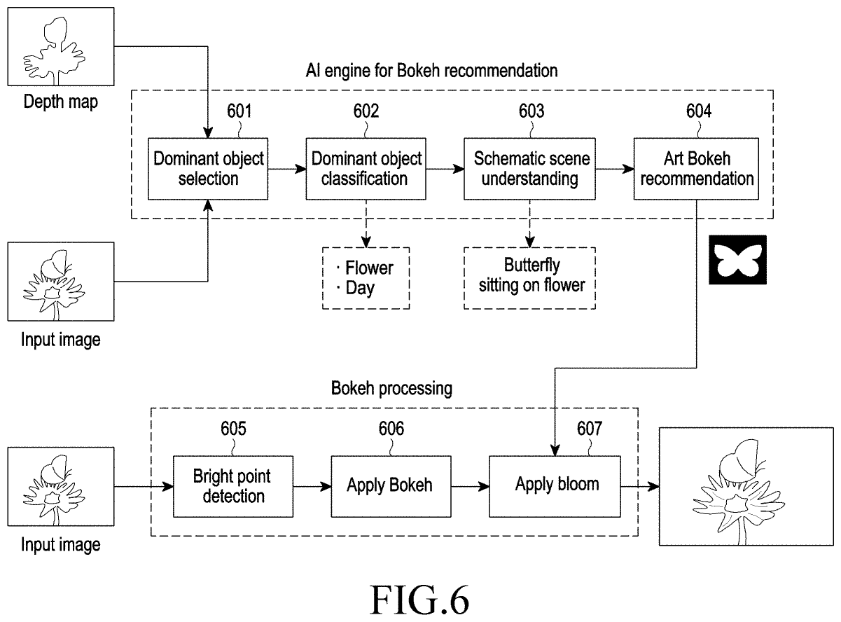

FIG. 6 is a schematic diagram illustrating steps in modifying the background of the image, according to an embodiment as disclosed herein. The electronic device 100 obtains the image of a butterfly sitting on a flower, and a depth map of the image from a Standard Exchange Format (SEF) file, where the image is stored as the Standard Exchange Format (SEF) file in the memory 140. The electronic device 100 selects (601) the dominant object in the foreground and the background of the image. Further, the electronic device 100 classifies (602) the dominant object in the foreground as the flower and the dominant object in the background as the day. Further, the electronic device 100 performs (603) schematic scene understanding for recognizing the shape of each object in the background. The electronic device 100 also performs schematic scene understanding for determining the context of the captured shot of the scene. The electronic device 100 determines the context of the captured shot of the scene as the butterfly sitting on the flower. Further, the electronic device 100 to identifies pre-defined shapes relating to the context of the image using the AI engine 120. Further, the electronic device 100 recommends (604) the shape of the butterfly (i.e. Art Bokeh) which relates to the context of the image.

The electronic device 100 detects (605) a bright point in the image using existing methods. Further, the electronic device 100 applies (606) a Bokeh effect to the image using the existing methods. Further, the electronic device 100 applies (607) the bloom to the image by transforming the shape of the objects in the background of the image with the recommended butterfly shape, based on the proposed method.

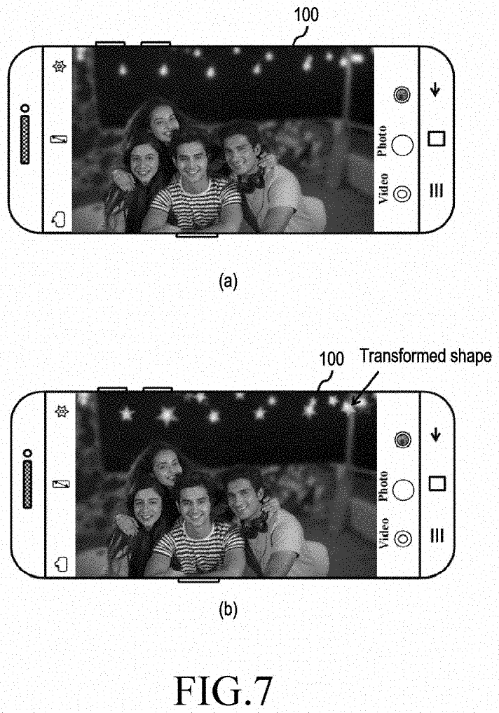

FIG. 7 illustrates an example scenario of modifying the background of the image based on the time information and the location information in the image by the electronic device 100, according to an embodiment as disclosed herein. Consider, a user is capturing the image of four friends siting in the outdoor location at the night time as shown in notation (b) of the FIG. 7, where the image is capturing in Bokeh mode using the electronic device 100. The background of the image includes decorative lights, a cricket bat and a sofa, where the background is blurred due to capturing the image in the Bokeh mode. The electronic device 100 recognizes the four friends in the image as the foreground object. Further, the electronic device 100 determines the four friends in the image as the dominant foreground object. The electronic device 100 recognizes the decorative lights, the cricket bat and the sofa as the background objects. Further, the electronic device 100 determines the decorative lights as the dominant background object based on the time information (i.e. night time) and the location information (i.e. outdoor location). Further, the electronic device 100 determines the context of the decorative lights by classifying the decorative lights to the class of night and outdoor.

Further, the electronic device 100 determines the star shape as the shape in the background pattern for the class of night and outdoor, based on the context of the decorative lights. The electronic device 100 determines the effect in the image as the blurring effect. The electronic device 100 determines the shape of the decorative lights in the image. The electronic device 100 modifies the background of the image by transforming the shape of the decorative lights to the star shape. Further, the electronic device 100 modifies the background of the image by blurring the transformed shape of the decorative lights as shown in notation (b) of the FIG. 7.

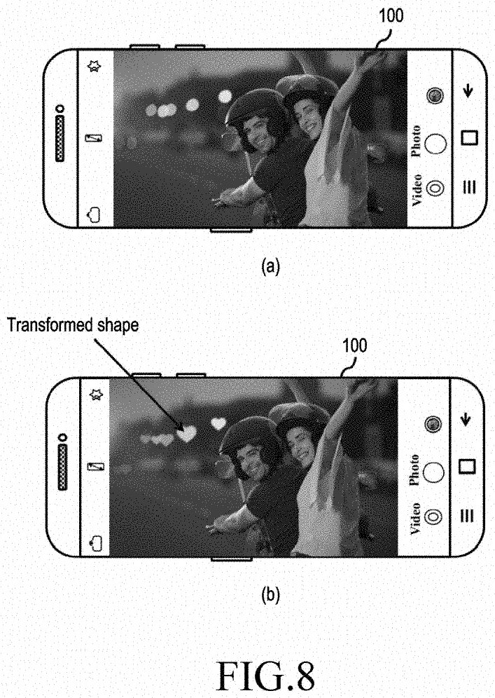

FIG. 8 illustrates an example scenario of modifying the background of the image based on the emotion in the foreground of the image and the time information and the location information of the image by the electronic device 100, according to an embodiment as disclosed herein. Consider, the user is capturing the image of a couple siting on a motor bike in a road at the night time as shown in notation (a) of the FIG. 8, where the image is capturing in the Bokeh mode using the electronic device 100. The couple is in the happy mood while capturing the image. The background of the image includes road side lights and the road, where the background is blurred due to capturing the image in the Bokeh mode. The electronic device 100 recognizes the couple and the bike as the foreground objects. The electronic device 100 recognizes the road side lights and the road as the background objects. Further, the electronic device 100 determines the couples in the image as the dominant foreground object based on the emotion (i.e. happy) in the foreground. The electronic device 100 determines the road side lights as the dominant background object based on the time information (i.e. night time) and the location information (i.e. road).

Further, the electronic device 100 determines the context of the couples by classifying the couples to the fourth generic class. Further, the electronic device 100 determines the heart shape as the shape in the background pattern for the fourth generic class, based on the context of the couples. The electronic device 100 determines the effect in the image as the blurring effect. The electronic device 100 determines the shape of the road side lights in the image. The electronic device 100 modifies the background of the image by transforming the shape of the road side lights to the heart shape. Further, the electronic device 100 modifies the background of the image by blurring the transformed shape of the road side lights as shown in notation (b) of the FIG. 8.

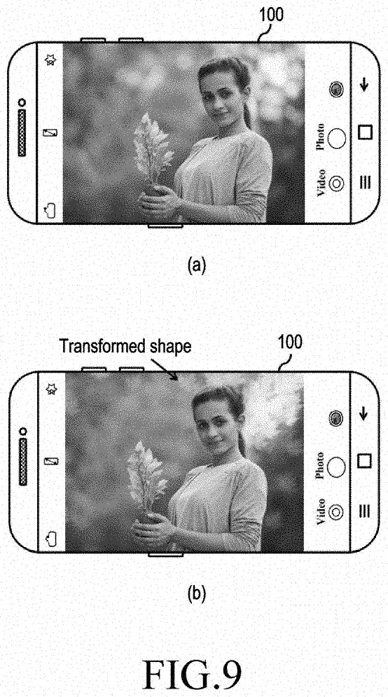

FIG. 9 illustrates an example scenario of modifying the background of the image based on the dominant foreground object and the greenery in the background of the image by the electronic device 100, according to an embodiment as disclosed herein. Consider, the user is capturing the image of a lady and a plant in a pot as shown in notation (a) of the FIG. 9, where the image is capturing in the Bokeh mode using the electronic device 100. The lady is holding the plant in the pot while capturing the image. The background of the image is the greenery with varying gradient in different background region. Further, the background is blurred due to capturing the image in the Bokeh mode. The electronic device 100 recognizes the lady and the plant in the pot as the foreground objects. The electronic device 100 recognizes the greenery with varying gradient in different background region as the background object. Further, the electronic device 100 determines the plant in the pot as the dominant foreground object based on the type of the scene (i.e. greenery). The electronic device 100 determines the greenery with varying gradient in different background region as the dominant background object based on the type of the scene (i.e. greenery).

Further, the electronic device 100 determines the context of the greenery with varying gradient by classifying the greenery with varying to the class of greenery. Further, the electronic device 100 determines the leaf shape as the shape in the background pattern for the class of greenery, based on the context of the greenery with varying gradient. The electronic device 100 determines the effect in the image as the blurring effect. The electronic device 100 determines the shape of the regions in the background with varying gradient of the greenery. The electronic device 100 modifies the background of the image by transforming the shape of the regions in the background with varying gradient of the greenery to the leaf shape. Further, the electronic device 100 modifies the background of the image by blurring the transformed shape of the region as shown in notation (b) of the FIG. 9.

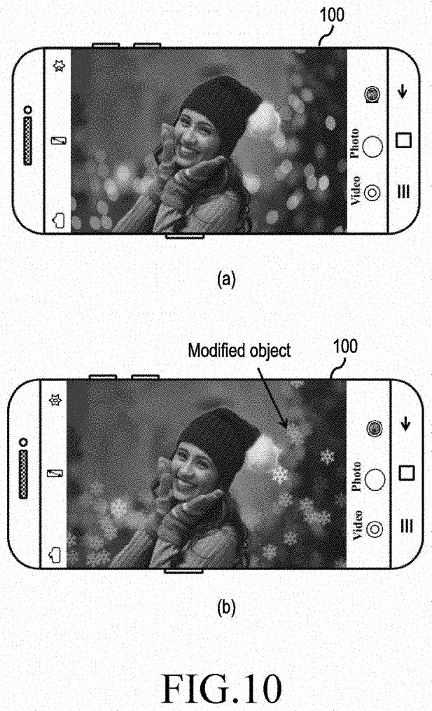

FIG. 10 illustrates an example scenario of modifying the background of the image based on the dominant foreground object and the weather information in the image by the electronic device 100, according to an embodiment as disclosed herein. Consider, the user is capturing the image of the lady standing in a cold place as shown in notation (a) of the FIG. 10, where the image is capturing in the Bokeh mode using the electronic device 100. The lady is wearing winter clothes while capturing the image. Flowers are present in the background of the image, where the background is blurred due to capturing the image in the Bokeh mode. The electronic device 100 recognizes the lady and the winter clothes as the foreground objects. The electronic device 100 recognizes the flowers as the background object. Further, the electronic device 100 determines the winter clothes as the dominant foreground object based on the event information (i.e. cold). The electronic device 100 determines the flowers as the dominant background object based on the based on the event information.

Further, the electronic device 100 determines the context of the flowers by classifying the flowers to the event class of cold. Further, the electronic device 100 determines the object in the background pattern for the class of cold, based on the context of the flowers. The electronic device 100 determines the effect in the image as the blurring effect. Further, the electronic device 100 modifies the background of the image by replacing the flowers in the background with the object in the background pattern for the event class of cold as shown in notation (b) of the FIG. 10, based on the blurring effect.

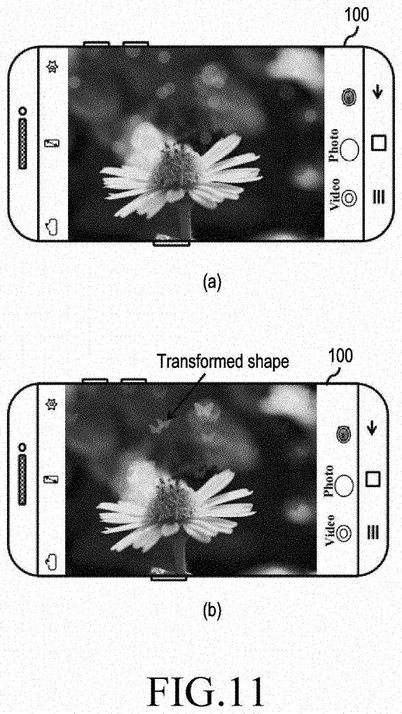

FIG. 11 illustrates an example scenario of modifying the background of the image based on the dominant foreground object and the greenery in the background of the image by the electronic device 100, according to an embodiment as disclosed herein. Consider, the user is capturing the image of the flower as shown in notation (a) of the FIG. 11, where the image is capturing in the Bokeh mode using the electronic device 100. The background of the image is the greenery with varying gradient in different background region. Further, the background is blurred due to capturing the image in the Bokeh mode. The electronic device 100 recognizes the flower as the foreground objects. The electronic device 100 recognizes the greenery with varying gradient in different background region as the background object. Further, the electronic device 100 determines the flower as the dominant foreground object based on the size of the flower. The electronic device 100 determines the greenery with varying gradient in different background region as the dominant background object based on the scene of greenery.

Further, the electronic device 100 determines the context of the flowers by classifying the flowers to the class of flower. Further, the electronic device 100 determines the butterfly shape in the background pattern for the class of flower, based on the context of the flower. The electronic device 100 determines the effect in the image as the blurring effect. Further, the electronic device 100 determines the shape of the regions in the background with varying gradient of the greenery. Further, the electronic device 100 modifies the background of the image by transforming the shape of the regions in the background with varying gradient of the greenery with the butterfly shape. Further, the electronic device 100 modifies the background of the image by blurring the transformed shape of the region as shown in notation (b) of the FIG. 11.

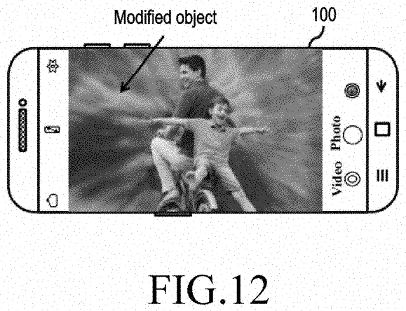

FIG. 12 illustrates an example scenario of modifying the background of the image based on the dominant foreground object and the motion of the foreground object by the electronic device 100, according to an embodiment as disclosed herein. Consider, the user is capturing the image of a father and a son traveling on a bicycle, where the image is capturing in the Bokeh mode using the electronic device 100. The father, the son and the bicycle is moving away from the electronic device 100 while capturing the image. The electronic device 100 recognizes the father, the son and the bicycle as the foreground objects. The electronic device 100 recognizes the background surface of the image as the background object. Further, the electronic device 100 determines the father, the son and the bicycle as the dominant foreground object based on the motion of the foreground object. The electronic device 100 classifies the dominant background object to the away motion class based on the motion of the foreground object. Further, the electronic device 100 modifies the background of the image by applying the motion blur effect to the background surface based on the away motion class.

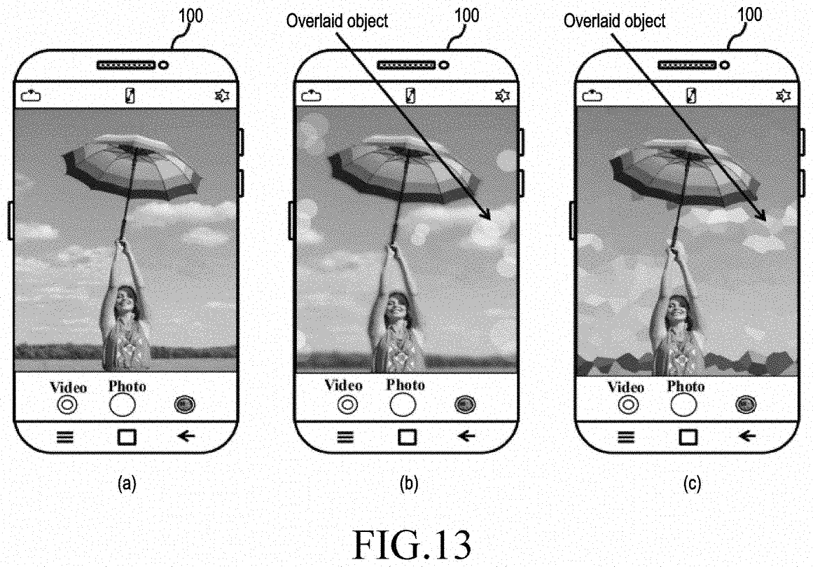

FIG. 13 illustrates an example scenario of transforming the object available in the background of the image with the shape available in the background pattern by the electronic device 100, according to an embodiment as disclosed herein. Consider, the user is capturing the image of the lady, holds an opened umbrella as shown in notation (a) of the FIG. 13, where the image is capturing in the Bokeh mode using the electronic device 100. The background of the image is a wheat field and sky with clouds, where the background is blurred due to capturing the image in the Bokeh mode. The climate is sunny while capturing the image. The electronic device 100 recognizes the lady and the opened umbrella as the foreground objects. The electronic device 100 recognizes the clouds and the wheat field as the background objects. Further, the electronic device 100 determines the opened umbrella as the dominant foreground object based on the event information (i.e. the weather information). Further, the electronic device 100 determines the context of the opened umbrella by classifying the opened umbrella to a class of sunny. Further, the electronic device 100 determines the object (i.e. Lens flare) in the background pattern for the class of sunny, based on the context of the opened umbrella. Further, the electronic device 100 modifies the background of the image by overlaying the clouds in the background with the object in the background pattern for the class of sunny as shown in notation (b) of the FIG. 13.

The user swipes on the display 150 of the electronic device 100. In response to detecting the swipe on the display 150, the electronic device 100 changes the background of the image by overlaying the clouds in the background with the object in the background pattern for the fourth generic class, as shown in notation (c) of the FIG. 13.

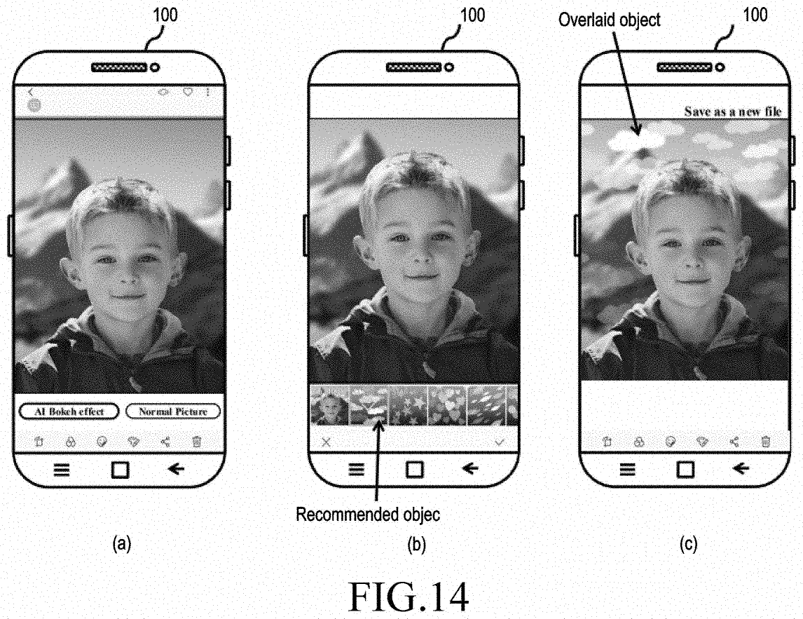

FIG. 14 illustrates an example scenario of recommending the object available in the background pattern based on the time information in the image by the electronic device 100 for modifying the background of the image, according to an embodiment as disclosed herein. Consider, the user is opening the image of a boy using a gallery application in the electronic device 100, as shown in notation (a) of the FIG. 14. The background of the image includes mountain, where the background is blurred due to capturing the image in the Bokeh mode. The time of capturing of the image is 6 PM.

In response to selecting an AI Bokeh effect option in the gallery application by the user, the electronic device 100 recognizes the boy as the foreground object. Further, the electronic device 100 recognizes the mountain as the background objects. The electronic device 100 determines the boy as the dominant foreground object based on the size of the foreground object. Further, the electronic device 100 determines the mountain as the dominant foreground object based on the event information (i.e. time information). Further, the electronic device 100 determines the context of the mountain by classifying the mountain to a class of evening. Further, the electronic device 100 determines the object (i.e. clouds) in the background pattern for the class of evening, based on the context of the mountain.

The electronic device 100 recommends the object (i.e. clouds) in the background pattern to the user as shown in notation (b) of the FIG. 14. The recommendation also includes the objects belongs to other classes. In response to selecting the recommended object (i.e. clouds) in the background pattern for the class of evening by the user, the electronic device 100 modifies the background of the image by partially overlaying the mountains in the background with the object (i.e. clouds) in the background pattern for the class of evening, as shown in notation (c) of the FIG. 14.

The embodiments disclosed herein can be implemented using at least one software program runningon at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for rendering a background in an image by an electronic device comprising:
recognizing, by the electronic device foreground objects and background objects of the image;
determining, by the electronic device, a context of the foreground objects and a context of the background objects in the image;
determining, by the electronic device a background pattern based on the context of the foreground objects and the context of the background objects;
modifying, by the electronic device, the background of the image based on the background pattern; and
displaying, by the electronic device the image with the modified background.

2. The method of claim 1, wherein modifying, by the electronic device the background of the image based on the background pattern comprising:
determining an effect and at least one of a shape, an object, and a surface based on the background pattern; and
transforming at least one of a shape, an object, and a surface available in the background of the image with at least one of the shape, the object, and the surface based on the effect.

3. The method of claim 2, wherein the transforming is done by at least one of:
blurring the shape, the object, and the surface available in the background of the image based on the effect;
overlaying the shape, the object, and the surface in the background pattern over the shape, the object, and the surface available in the background of the image based on the effect; and
replacing the shape, the object, and the surface available in the background of the image with the shape, the object, and the surface in the background pattern based on the effect.

4. The method of claim 1, wherein determining, by the electronic device the context of the foreground objects comprising:
determining a dominant foreground object from the foreground objects based on at least one of an activity in a foreground, an event information, a shape of the foreground object, a size of the foreground object, and a motion of the foreground object;
classifying the dominant foreground object; and
determining the context of the foreground objects based on the category of the dominant foreground object.

5. The method of claim 1, wherein determining, by the electronic device, the context of the background objects comprising:
determining a dominant background object from the background objects based on at least one of an activity in the background, an event information, a shape of the background object, a size of the background object, and a motion of the background object;
classifying the dominant background object; and
determining the context of the background objects based on the category of the dominant background object.

6. An electronic device for rendering a background in an image, comprising:
a processor;
a memory comprising the image; and
a background modification engine, coupled to the processor and the memory, configured to:
recognize foreground objects and background objects in the image, determine a context of the foreground objects and a context of the background objects in the image,
determine a background pattern based on the context of the foreground objects and the context of the background objects,
modify the background of the image based on the background pattern, and
cause to display the image with the modified background.

7. The electronic device of claim 6, wherein the background modification engine further configured to:
determine an effect and at least one of a shape, an object, and a surface based on the background pattern, and
transform at least one of a shape, an object and a surface available in the background of the image with at least one of the shape, the object, and the surface based on the effect.

8. An intelligent background rendering method in an image capture, comprising:
identifying objects and/or surfaces present in a background of a captured shot;
performing scene analysis to recognize a shape of each object or surface in the background;
performing scene analysis of objects present in a foreground to determine a context of the captured shot;
identifying pre-defined shapes or patterns from a repository, related to the context of the captured shot; and,
transforming at least in part, the shape of the objects or surfaces present in the background with that of the pre-defined shapes or patterns related to the context of the captured shot.

9. The method of claim 8, wherein transforming at least in part, the shape of the objects and/or surfaces present in the background with that of the pre-defined shapes or patterns related to the context of the captured shot comprises recommending the shape of the objects and/or surfaces present in the background with that of the pre-defined shapes or patterns related to the context of the captured shot.

10. The method of claim 8, wherein the objects or surfaces in the background are blurred.

11. The method of claim 8, wherein transforming the shape includes overlaying the objects or surfaces with the pre-defined shapes.

12. The method of claim 8, wherein transforming the shape includes replacing the objects or surfaces with the pre-defined shapes.

13. An electronic device for intelligent background rendering in an image capture, comprising:
a processor;
a memory comprising a captured shot;
an artificial intelligence engine coupled to the processor and the memory; and
a background modification engine, coupled to the processor and the memory and, configured to:
identify objects or surfaces present in a background of the captured shot,
perform scene analysis to recognize a shape of each object or surface in the background,
perform scene analysis of objects present in a foreground to determine a context of the captured shot,
configure the artificial intelligence engine to identify pre-defined shapes or patterns from a repository, related to the context of the captured shot, and
transform at least in part, the shape of the objects or surfaces present in the background with that of the pre-defined shapes or patterns related to the context of the captured shot.

14. The electronic device of claim 13, wherein the background modification engine further configured to:
recommend the shape of the objects or surfaces present in the background with that of pre-defined shapes or patterns related to the context of the captured shot.

15. The electronic device of claim 13, wherein the objects or surfaces in the background are blurred.

16. The electronic device of claim 13, wherein the background modification engine transforms the shape by overlaying the objects or surfaces with the pre-defined shapes.

17. The electronic device of claim 13, wherein the background modification engine transforms the shape by replacing the objects or surfaces with the pre-defined shapes.

18. The electronic device of claim 6, wherein the transform is done by at least one of:
blurring the shape, the object, and the surface available in the background of the image based on the effect,
overlaying the shape, the object, and the surface in the background pattern over the shape, the object, and the surface available in the background of the image based on the effect, and
replacing the shape, the object, and the surface available in the background of the image with the shape, the object, and the surface in the background pattern based on the effect.

19. The electronic device of claim 6, wherein the background modification engine further configured to:
determine a dominant foreground object from the foreground objects based on at least one of an activity in a foreground, an event information, a shape of the foreground object, a size of the foreground object, and a motion of the foreground object,
classify the dominant foreground object, and
determine the context of the foreground objects based on the category of the dominant foreground object.

20. The electronic device of claim 6, wherein the background modification engine further configured to:
determine a dominant background object from the background objects based on at least one of an activity in a background, an event information, a shape of the background object, a size of the background object, and a motion of the background object,
classify the dominant background object, and
determine the context of the background objects based on the category of the dominant background object.
